(19) United States
(12) Patent Application Publication
(10) Pub. No.: US 2017/0344137 A1
(43) Pub. Date: Nov. 30, 2017

(54) NON-TRANSITORY COMPUTER READABLE MEDIUM AND INFORMATION PROCESSING APPARATUS

(71) Applicant: FUJI XEROX CO., LTD., Tokyo (JP)

(72) Inventors: Takeshi NOGUCHI, Kanagawa (JP); Shunji SAKAI, Kanagawa (JP); Hideki BABA, Kanagawa (JP)

(73) Assignee: FUJI XEROX CO., LTD., Tokyo (JP)

(21) Appl. No.: 15/371,856

(22) Filed: Dec. 7, 2016

(30) Foreign Application Priority Data
May 31, 2016 (JP) 2016-109383

(51) Int. Cl. G06F 3/0354; G06F 3/038; G06F 17/24; G06K 9/00

(52) U.S. Cl. CPC G06F 3/03545; G06K 9/00402; G06F 3/0383; G06F 17/24

(57) ABSTRACT

A non-transitory computer readable medium stores a program causing a computer to execute a process. The process includes: generating a first path which represents positions on a medium specified by a digital pen; obtaining a second path which represents positions on the medium specified by the digital pen and which satisfies a predetermined condition; obtaining information for specifying an area on the medium, the area having a predetermined positional relationship with the second path; and erasing the first path in accordance with a positional relationship between the area and the first path.

### CROSS-REFERENCE TO RELATED APPLICATIONS

This application is based on and claims priority under 35 USC 119 from Japanese Patent Application No. 2016-109383 filed May 31, 2016.

### BACKGROUND

### Technical Field

The present invention relates to a non-transitory computer readable medium and an information processing apparatus.

### SUMMARY

According to an aspect of the invention, there is provided a non-transitory computer readable medium storing a program causing a computer to execute a process. The process includes: generating a first path which represents positions on a medium specified by a digital pen; obtaining a second path which represents positions on the medium specified by the digital pen and which satisfies a predetermined condition; obtaining information for specifying an area on the medium, the area having a predetermined positional relationship with the second path; and erasing the first path in accordance with a positional relationship between the area and the first path.

### BRIEF DESCRIPTION OF THE DRAWINGS

An exemplary embodiment of the present invention will be described in detail based on the following figures, wherein:

FIG. 1 illustrates an example of the configuration of a digital pen system according to an exemplary embodiment;

FIG. 2 illustrates an example of a set of coded images;

FIG. 3 illustrates an example of a form;

FIG. 4 illustrates an example of the configuration of a digital pen;

FIG. 5 is a block diagram illustrating an example of the hardware configuration of an information processing apparatus;

FIGS. 6A through 6C illustrate an example of an issue to be addressed in the related art;

FIG. 7 is a block diagram illustrating an example of the functional configuration of the information processing apparatus;

FIGS. 8A and 8B are a sequence chart illustrating an example of the operation performed by the information processing apparatus according to a first operation example;

FIGS. 9A through 9C illustrate an example of erasing of strokes in the first operation example;

FIG. 10 illustrates examples of sub-areas;

FIG. 11 is a flowchart illustrating an example of the operation performed by the information processing apparatus according to a second operation example;

FIGS. 12A through 12C illustrate an example of erasing of strokes in the second operation example;

FIG. 13 is a block diagram illustrating an example of the functional configuration of the information processing apparatus according to a third operation example;

FIG. 14 is a sequence chart illustrating an example of the operation performed by the information processing apparatus according to the third operation example; and

FIGS. 15A through 15C illustrate an example of erasing of strokes in the third operation example.

### DETAILED DESCRIPTION

### 1. Configuration

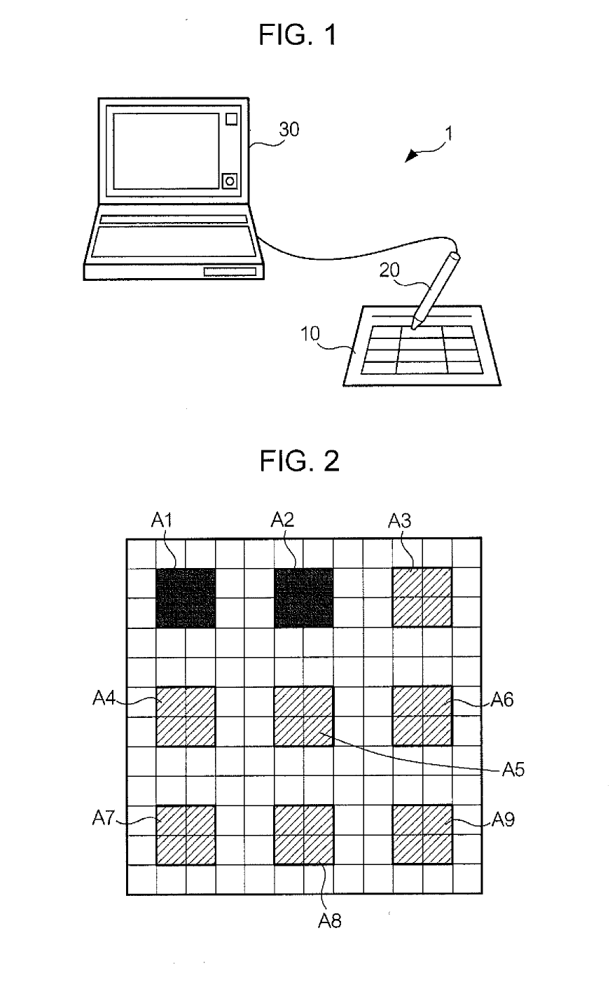

FIG. 1 illustrates an example of the configuration of a digital pen system 1 according to an exemplary embodiment. In the digital pen system 1, an information processing apparatus 30 performs processing in accordance with strokes of a digital pen 20 on a medium 10. The digital pen system 1 may be used for inspections of vehicles and plants and for summing up and managing the results of check operations, such as stocktaking (inventory checking). The digital pen system 1 includes the medium 10, the digital pen 20, and the information processing apparatus 30. The medium 10 is used for inputting information by using the digital pen 20. Position information indicating positions on the medium 10 and identification information for identifying the medium 10 are coded by a predetermined coding method and are formed into images. On the surface of the medium 10, such coded images are formed. These coded images are readable by the digital pen 20 but are invisible to the human eye or are formed in a size or a color that is hard to view by the human eye. On the surface of the medium 10, an image indicating characters and lines having a predetermined format for inputting information is formed. This image corresponds to a form and will hereinafter be called a “form image”. This form image is formed in a size and a color that are visible to the human eye. The medium 10 is configured in a shape like a sheet, such as paper and an overhead projector (OHP) sheet. At least one of a coded image and a form image is formed on the medium 10 by using an electrophotographic image forming apparatus, for example. A form indicated by a form image formed on the medium 10 will simply be called a “form”.

The digital pen 20 is an input device used by a user to input information. In this example, the digital pen 20 has the following two functions. A first function is a function of attaching or fixing a pigment, a dye, or an ink containing thereof onto the medium 10. A second function is a function of outputting information indicating a path (strokes) generated by moving the digital pen 20 on the medium 10 while keeping the tip of the digital pen 20 in contact with the surface of the medium 10. Hereinafter, such a path may also be called “strokes” and the information indicating the path may also be called “stroke information”. To achieve the second function, the digital pen 20 reads coded images formed on the medium 10 and generates stroke information by using the read coded images.

FIG. 2 illustrates an example of a set of coded images. The coded image is an image generated by coding information. The coded information includes at least information for specifying positions (coordinates) on the medium 10. The coded information may also include identification information for identifying the medium 10. In this example, nine-bit information is converted into information representing the presence or the absence of nine dot images. In FIG. 2, areas A1 through A9 are areas in which dot images may be formed. On the surface of the medium 10, coded images such as those shown in FIG. 2 are disposed at regular intervals. The positions and orientations of a set of coded images are specified by an image (not shown) used for this purpose. This image may be disposed inside or outside of the coded images.

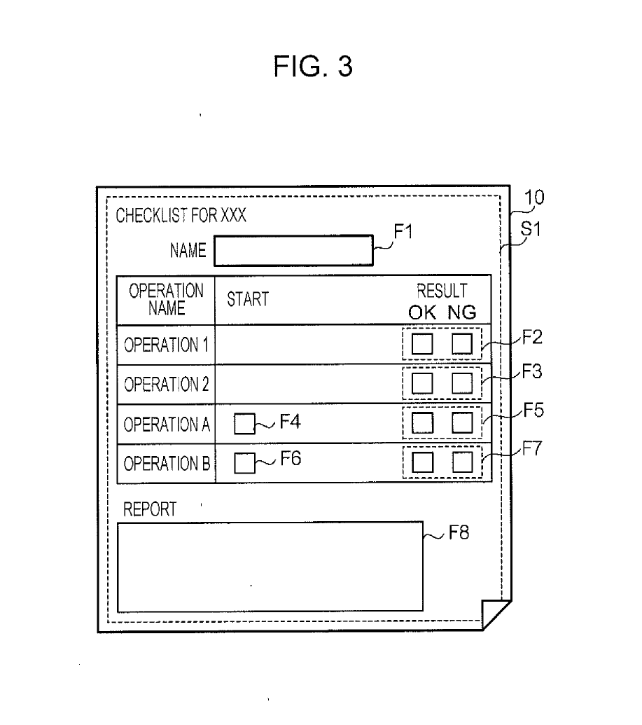

FIG. 3 illustrates an example of a form S1. In this example, as steps performed by a user, four operations, “operation 1”, “operation 2”, “operation A”, and “operation B”, are specified. Concerning these steps, the form S1 includes areas (entry columns or fields) (hereinafter may also be called “fields”) F1 through F8 where an operator inputs characters or graphics. In the field F1, the name of the operator in charge of the operations (that is, the name of the user) is input. In the field F2, the operator inputs a check mark when “operation 1” is completed. In the field F3, the operator inputs a check mark when “operation 2” is completed. In the field F4, the operator inputs characters or graphics when starting “operation A”. In the field F5, the operator inputs a check mark when “operation A” is completed. In the field F6, the operator inputs characters or graphics when starting “operation B”. In the field F7, the operator inputs a check mark when “operation B” is completed. In the field F8, the operator writes comments about operation results, for example. In the fields F2, F3, F5, and F7, the operator checks one of checkboxes “OK” and “NG” when the operation is completed.

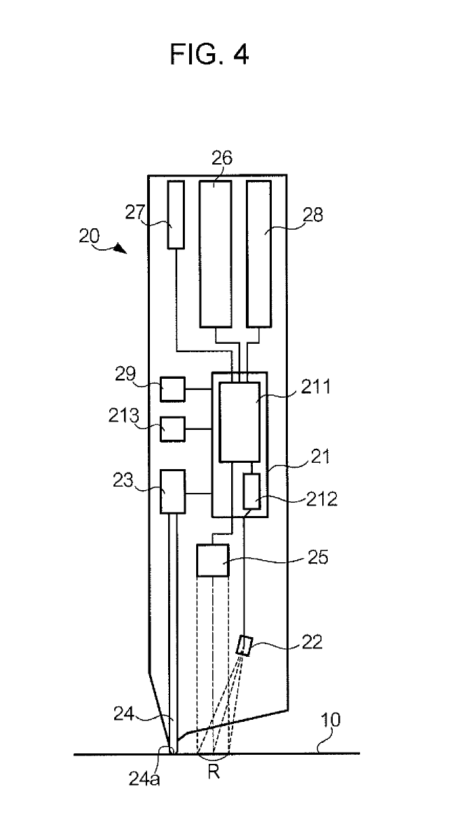

FIG. 4 illustrates an example of the configuration of the digital pen 20. The digital pen 20 includes a controller 21, an irradiating unit 22, a pressure sensor 23, a refill 24, an imaging device 25, a memory 26, an input-and-output unit 27, a battery 28, and a memory 29.

The irradiating unit 22 applies light (for example, infrared) when reading a coded image from the medium 10. The light is applied to an imaging range R on the medium 10. The imaging device 25 captures an image represented by light applied from the irradiating unit 22 and reflected by the medium 10 at a predetermined frame rate (for example, 60 frames per second (fps)). An image obtained by the imaging device 25 is called a “captured image”.

The pressure sensor 23 detects the writing pressure, more specifically, the pressure acting on the refill 24. The refill 24 has a function of attaching or fixing a pigment, a dye, or an ink containing thereof onto the medium 10 and a function of transferring the pressure applied to the tip of the digital pen 20 to the pressure sensor 23. To achieve the first function, the refill 24 is configured to store an ink therein and discharge the ink in accordance with the movement of the tip of the digital pen 20. The refill 24 is configured as in the tip of a ballpoint pen, for example.

The controller 21 controls the elements of the digital pen 20. The controller 21 includes a signal processing circuit 211, a drive circuit 212, and a timer 213. The timer 213 generates time information indicating the current time and outputs the generated time information. The signal processing circuit 211 includes a processor for performing signal processing for the digital pen 20. For example, the signal processing circuit 211 analyzes a captured image. More specifically, the signal processing circuit 211 decodes information indicated by coded images included in a captured image so as to extract identification information and position information. The drive circuit 212 controls the driving of the irradiating unit 22. For example, the drive circuit 212 controls the timing at which the irradiating unit 22 applies light to the medium 10. More specifically, when the pressure sensor 23 is detecting the pressure acting on the refill 24, the drive circuit 212 causes the irradiating unit 22 to apply light to the medium 10.

The memory 26 stores identification information and position information extracted by the signal processing circuit 211 and time information output from the timer 213. The input-and-output unit 27 is an interface for sending and receiving data with other devices via a wired or wireless medium. In this example, the input-and-output unit 27 particularly sends identification information, position information, and time information to the information processing apparatus 30 as stroke information.

The battery 28 is, for example, a storage battery, and supplies power for driving the digital pen 20 to the individual elements. The memory 29 stores identification information concerning the digital pen 20.

In this example, when the writing pressure detected by the pressure sensor 23 exceeds a predetermined threshold, the controller 21 starts to read identification information and position information and to obtain time information from the timer 213. The controller 21 continues reading identification information and position information at predetermined regular time intervals until the pressure detected by the pressure sensor 23 is reduced to the predetermined threshold. When the detected pressure is reduced to the predetermined threshold (that is, when the tip of the digital pen 20 is separated from the medium 10), the controller 21 stores in the memory 26 plural pairs of identification information and position information and time information read and obtained during a period from when the controller 21 starts to read and obtain the information until when the controller 21 finishes reading and obtaining the information. The identification information, position information, and time information are stored as a set of stroke information. In this case, as the time information, the reading start time of each of the plural items of position information is obtained. In the memory 26, identification information and position information are stored in the units of strokes, and time information indicating the reading start time of each stroke is stored. “Stroke” refers to a path through which the tip of the digital pen 20 moves on the medium 10 during a period from when the tip starts to contact the medium 10 until when the tip is separated from the medium 10.

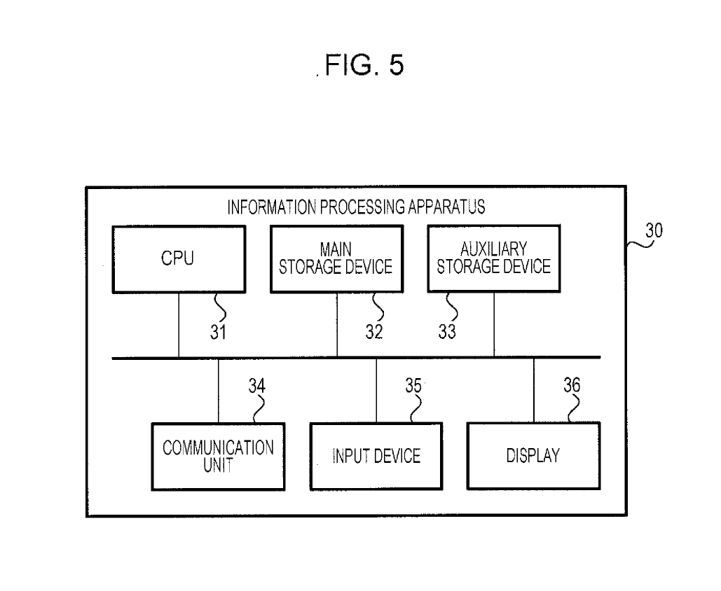

FIG. 5 illustrates an example of the hardware configuration of the information processing apparatus 30. The information processing apparatus 30 is a computer including a central processing unit (CPU) 31, a main storage device 32, an auxiliary storage device 33, a communication unit 34, an input device 35, and a display 36.

The CPU 31 is a processor executing various operations. The main storage device 32 includes a read only memory (ROM) and a random access memory (RAM). The auxiliary storage device 33 is a non-volatile storage device storing programs and data, and includes a hard disk drive (HDD) or a solid state drive (SSD), for example. The CPU 31 uses the RAM as a work area and executes a program stored in the ROM or the auxiliary storage device 33.

The communication unit 34 is an interface for communicating with other devices. In this example, the communication unit 34 particularly receives stroke information from the digital pen 20. The input device 35 is used by a user to input instructions or information into the CPU 31. The input device 35 includes at least one of a keyboard, a touchscreen, and a microphone. The display 36 is used for displaying information, and includes a liquid crystal display (LCD), for example.

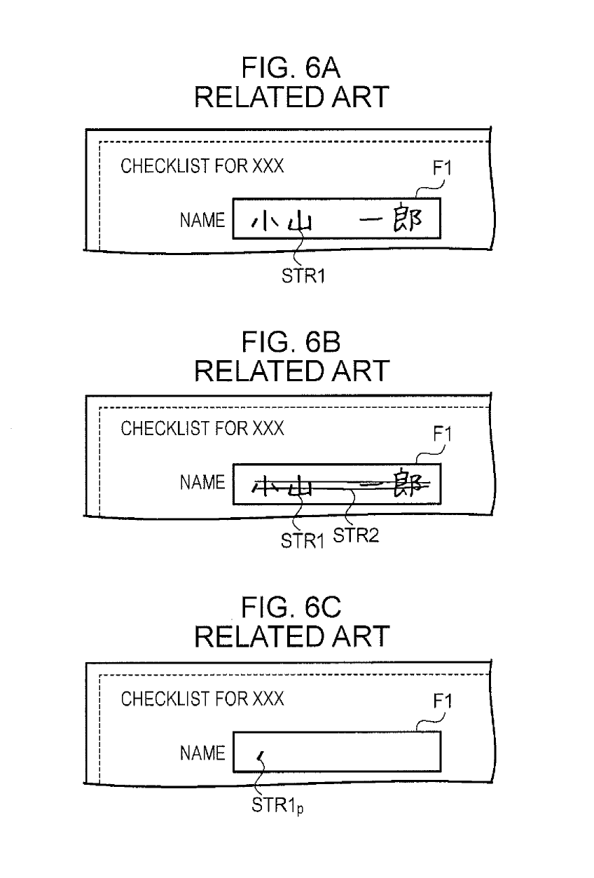

FIGS. 6A through 6C illustrate an example of an issue to be addressed in the related art. FIG. 6A illustrates an example of characters (stroke STR1) written on the medium 10 by the digital pen 20 in the related art. In this example, characters “ [symbol] ” are written as the name of the operator in charge of the operations in the field F1 of the form. These characters are written by a path (an example of a first path) of the digital pen 20. FIG. 6B illustrates an example of strikethrough (stroke STR2) written on the medium 10 in the related art. The strikethrough is a line drawn by a path (an example of a second path) for specifying an image object to be erased. Operation modes of the digital pen 20 are a first operation mode in which data concerning an image object (hereinafter called “writing data”) is generated in accordance with a path and a second operation mode in which an instruction to erase writing data is input. The first operation mode will be called “writing mode”, and the second operation mode will be called “erasing mode”. The first and second operation modes are switched by using a switch (not shown) provided in the digital pen 20, for example.

In the related art, writing data corresponding to a path overlapping the strikethrough is erased. In the example shown in FIG. 6B, although the strikethrough overlaps the majority of the characters “ [symbol] ”, it does not cover the left-edge stroke of the character “ [symbol] ”. The character “ [symbol] ” is constituted by three strokes, and data concerning each stroke is individually stored. According to this strikethrough, the left-edge stroke of the character “ [symbol] ” is not erased and the data concerning this stroke remains. FIG. 6C illustrates an example of a path indicated by the writing data after part of the characters “ [symbol] ” is erased by the strikethrough shown in FIG. 6B. The user has intended to erase the data indicating the entire characters “ [symbol] ”. However, the strikethrough is incompletely drawn, and data concerning part of the path (stroke STR1ₚ) is not erased and remains. In this manner, the strikethrough may become incomplete due to the reasons, such as the user moves the digital pen 20 too quickly, the initial writing pressure is too weak, and there is a considerable delay in starting to read position information upon detecting by the pressure sensor 23 that the writing pressure exceeds a threshold. The digital pen system 1 of this exemplary embodiment addresses such an issue.

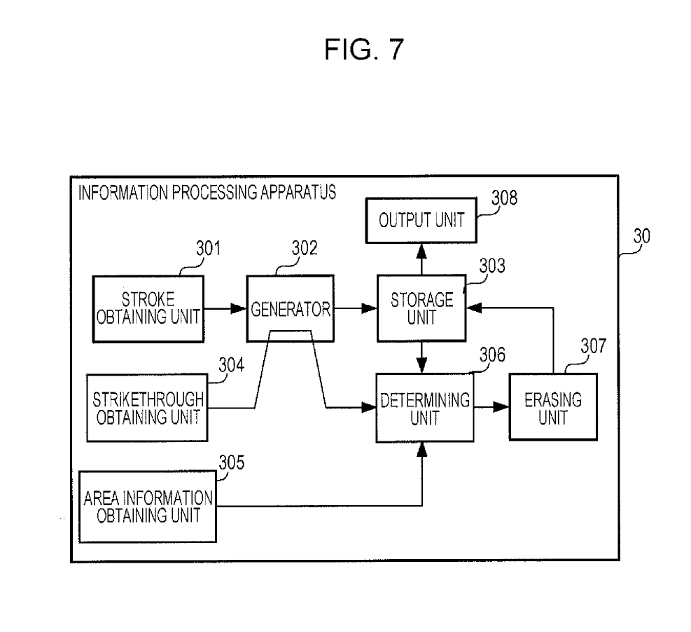

FIG. 7 illustrates an example of the functional configuration of the information processing apparatus 30. The information processing apparatus 30 includes a stroke obtaining unit 301, a generator 302, a storage unit 303, a strikethrough obtaining unit 304, an area information obtaining unit 305, a determining unit 306, an erasing unit 307, and an output unit 308.

The stroke obtaining unit 301 obtains stroke information in the writing mode from the digital pen 20. The generator 302 generates data (writing data) concerning image objects corresponding to the stroke information obtained by the stroke obtaining unit 301. The storage unit 303 stores the writing data generated by the generator 302. The strikethrough obtaining unit 304 (an example of a first obtaining unit) obtains stroke information in the erasing mode from the digital pen 20. The area information obtaining unit 305 (an example of a second obtaining unit) obtains information for specifying areas on the medium 10 (for example, fields F1 through F8 in FIG. 3). The determining unit 306 determines whether writing data will be erased in accordance with positional relationship between the areas specified by the information obtained by the area information obtaining unit 305 and a path indicated by the stroke information which is obtained by the strikethrough obtaining unit 304 and which satisfies a predetermined condition. The predetermined condition is a condition that the operation mode of the digital pen 20 is the erasing mode. If the determining unit 306 determines that the writing data will be erased, the erasing unit 307 performs processing for specifying that at least part of the writing data will be erased from the storage unit 303, and more specifically, it performs processing for erasing the data. The output unit 308 outputs the writing data stored in the storage unit 303.

In this exemplary embodiment, a program for processing stroke information (hereinafter called a “digital pen program”) is stored in the auxiliary storage device 33 of the information processing apparatus 30. As a result of the CPU 31 executing this digital pen program, the functions shown in FIG. 7 are implemented in the computer. The CPU 31 executing the digital pen program corresponds to an example of the stroke obtaining unit 301, the generator 302, the strikethrough obtaining unit 304, the area information obtaining unit 305, the determining unit 306, and the erasing unit 307. At least one of the main storage device 32 and the auxiliary storage device 33 is an example of the storage unit 303. The communication unit 34 or the display 36 is an example of the output unit 308. If the communication unit 34 serves as the output unit 308, “output” means that writing data is output to another-device. If the display 36 serves as the output unit 308, “output” means that images of image objects indicated by the writing data are displayed on the display 36.

### 2. Operation

### 2-1. First Operation Example

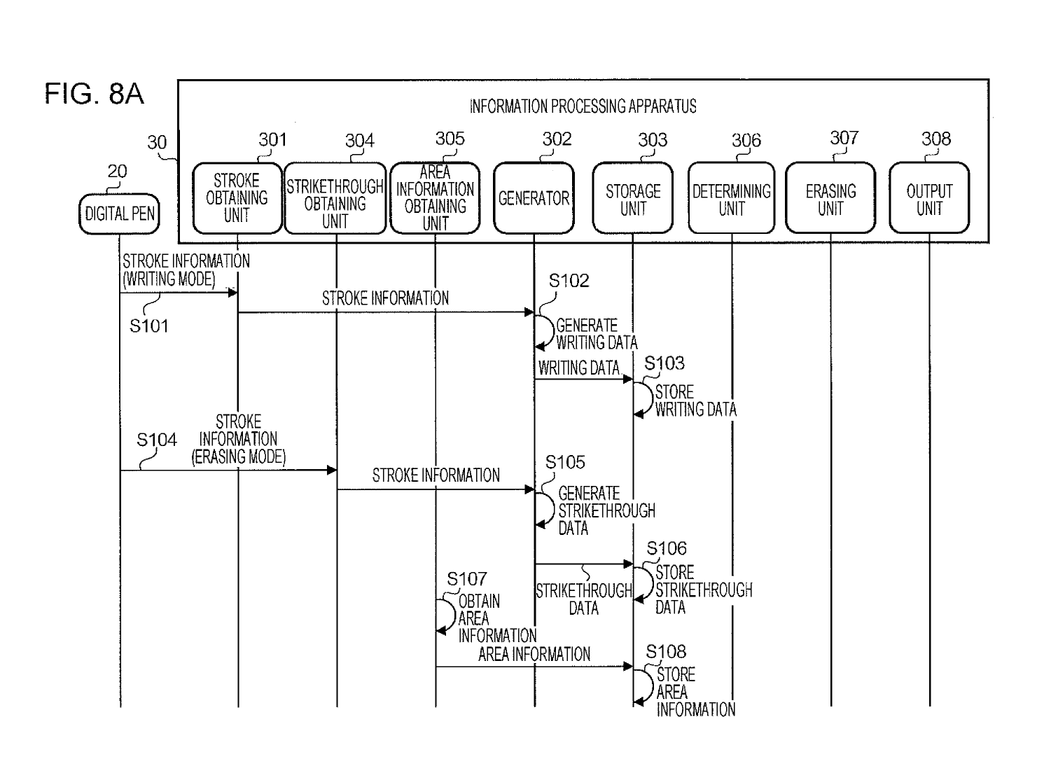

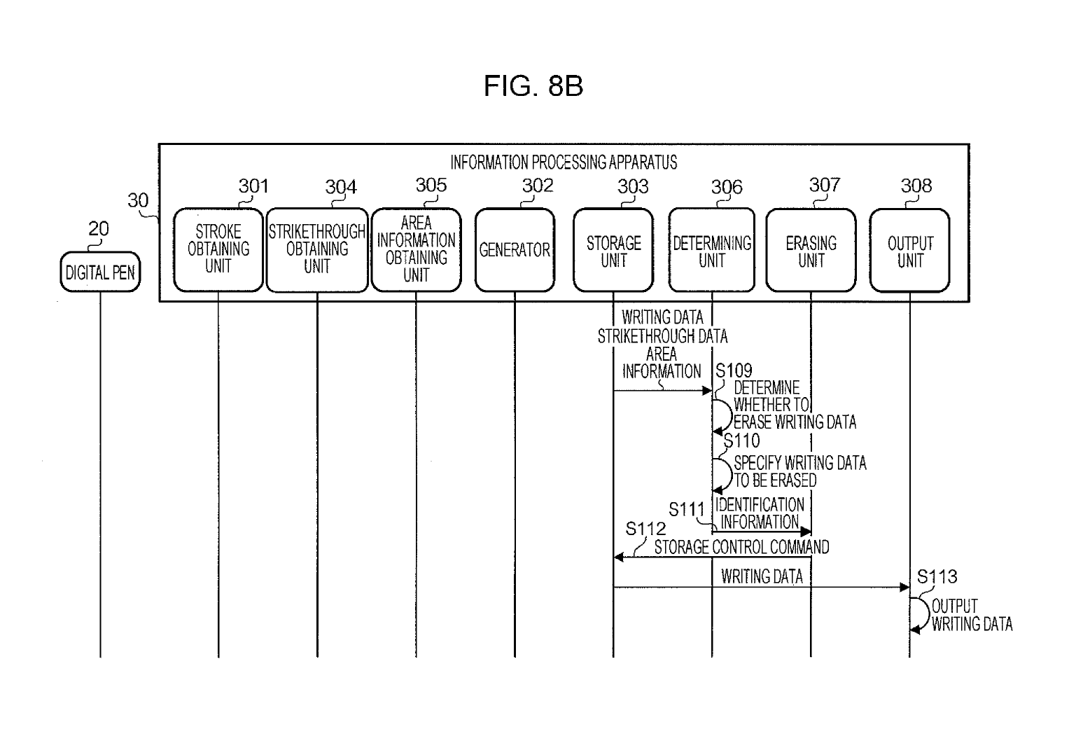

FIGS. 8A and 8B are a sequence chart illustrating an example of the operation performed by the information processing apparatus 30 according to a first operation example. Processing shown in FIGS. 8A and 8B is started in response to the initiating of the digital pen program in the information processing apparatus 30, for example. The processing will be described below such that the functional elements shown in FIG. 7 implemented by the digital pen program execute the processing. This however means that the CPU 31 executes the processing in cooperation with the other hardware elements shown in FIG. 5 as a result of executing the digital pen program.

In step S101, the stroke obtaining unit 301 obtains stroke information in the writing mode from the digital pen 20. Then, in step S102, the generator 302 generates writing data from the obtained stroke information. The writing data indicates a path of the digital pen 20 in the writing mode. In step S103, the storage unit 303 stores the generated writing data. The writing data is stored for each stroke, for example. Alternatively, two or more strokes may be grouped and stored as a set of writing data.

In step S104, the strikethrough obtaining unit 304 obtains stroke information in the erasing mode from the digital pen 20. In step S105, the generator 302 generates strikethrough data from the obtained stroke information. The strikethrough data indicates a path of the digital pen 20 in the erasing mode. In step S106, the storage unit 303 stores the generated strikethrough data. The strikethrough data is stored for each stroke, for example. Alternatively, two or more strokes may be grouped and stored as a set of strikethrough data.

In step S107, the area information obtaining unit 305 obtains area information concerning the areas on the medium 10. The area information is used for specifying areas (fields F1 through F8 in FIG. 3) defined in a form (FIG. 3). The areas indicated by the area information are specified based on the relationship between the area information and position information obtained from coded images formed on the medium 10. The form is specified by the identification information concerning the medium 10. In step S108, the storage unit 303 stores the area information.

In step S109, the determining unit 306 determines whether to erase the writing data. More specifically, the determining unit 306 refers to the information stored in the storage unit 303, and then specifies an area having a predetermined positional relationship (a predetermined condition) with the strikethrough as a subject area among the plural areas indicated by the area information. In this example, the predetermined condition is a condition that the subject area overlaps the strikethrough, that is, the strikethrough is at least partially contained in this area. In the example in FIG. 6B, the field F1 is specified as a subject area, for example. Step S109 is executed in response to the generation of a new item of strikethrough data.

In step S110, the determining unit 306 specifies, as data to be erased, writing data concerning all strokes having a predetermined positional relationship (a predetermined condition) with the subject area specified in step S109 among the items of writing data stored in the storage unit 303. The predetermined condition is, for example, a condition that at least part of each of the strokes is contained in the subject area. In step S111, the determining unit 306 supplies information for identifying the writing data specified as the data to be erased to the erasing unit 307.

In step S112, the erasing unit 307 performs processing on the subject data specified as the data to be erased so that the subject data can be distinguished from the other items of data which will not be erased. More specifically, the erasing unit 307 performs processing for erasing the subject data from the storage unit 303, for example. Alternatively, the erasing unit 307 may store a flag indicating that the subject data will be erased in the storage unit 303.

In step S113, the output unit 308 outputs the writing data stored in the storage unit 303. For example, the output unit 308 displays an image in accordance with the writing data. In this image, strokes to be erased are not included. Alternatively, strokes to be erased are displayed in a different color, for example, so that they can be distinguished from strokes which will not be erased.

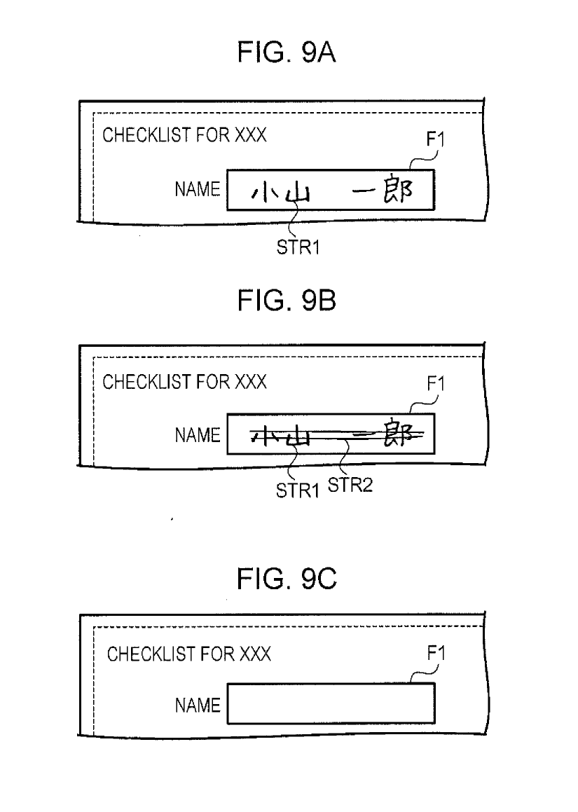

FIGS. 9A through 9C illustrate an example of erasing of strokes in the first operation example. The writing data (FIG. 9A) and the strikethrough data (FIG. 9B) are the same as those shown in FIGS. 6A and 6B, respectively. In this example, all the strokes including the left-edge stroke in the character “ [symbol] ” are erased, as shown in FIG. 9C. In the first operation example, items of writing data concerning all the strokes included in the same area as that of the strikethrough are specified as data to be erased. Thus, even if the strikethrough is drawn incompletely, the possibility that erasing of the subject writing data will be omitted is small.

The order of steps of the processing is not restricted to that discussed above. For example, steps S107 and S108 may be executed prior to step S104 or S101.

### 2-2. Second Operation Example

A second operation example will now be described below. In the second operation example, at least one of areas in a form includes plural sub-areas (sub-fields). Sub-areas are defined by area information. The area including sub-areas may be called a “principal area” so that it can be distinguished from sub-areas. Concerning the principal area including sub-areas, a determination as to whether writing data will be erased is made for each sub-area.

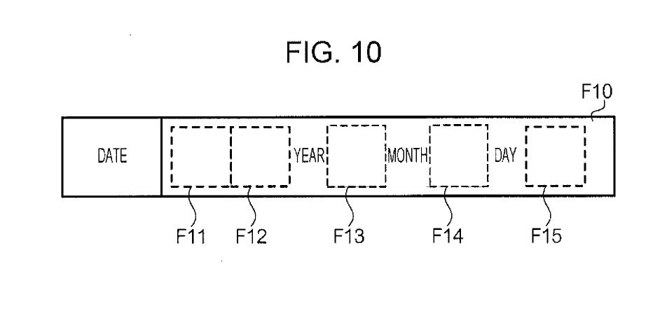

FIG. 10 illustrates an example of sub-areas. In this example, a principal field F10 includes sub-fields F11 through F15. The principal field F10 is an area where a date (year, month, day, and the day of the week) is input. The sub-field F11 is a left half portion of the area where the year is input. The sub-field F12 is a right half portion of the area where the year is input. In the sub-field F13, the month is input. In the sub-field F14, the day is input. In the sub-field F15, the day of the week is input.

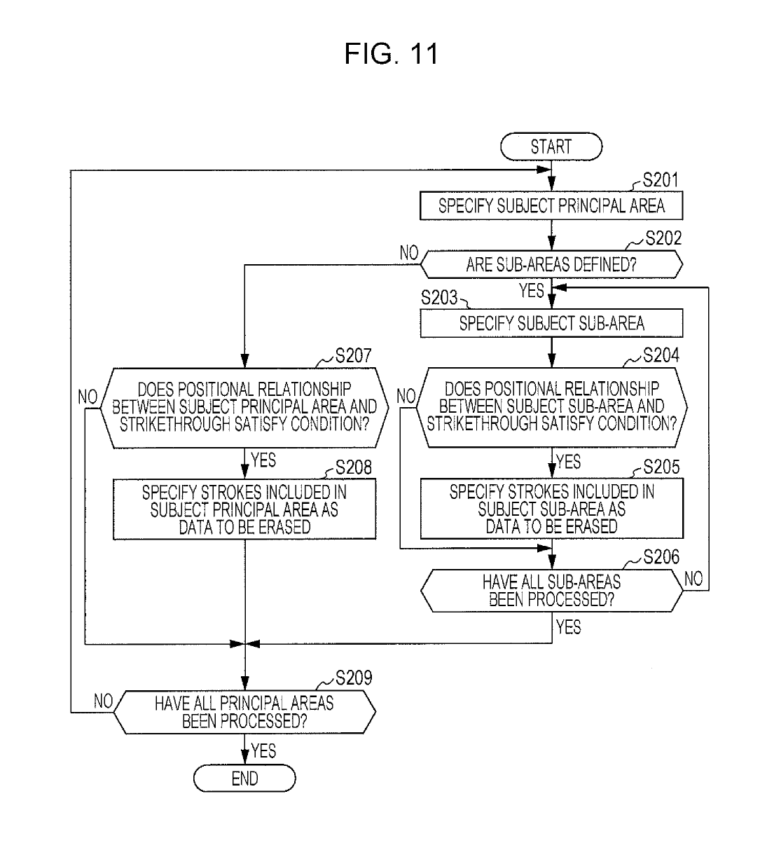

FIG. 11 is a flowchart illustrating an example of the operation performed by the information processing apparatus 30 according to the second operation example. The flowchart in FIG. 11 indicates details of steps S109 and S110 executed by the determining unit 306 in the flowchart of FIGS. 8A and 8B.

In step S201, the determining unit 306 specifies one subject principal area from among one or more principal areas (hereinafter called “subject principal area candidates”) having a positional relationship with strikethrough that satisfies a predetermined condition. The subject principal area is sequentially specified from the subject principal area candidates in accordance with a predetermined order.

In step S202, the determining unit 306 determines whether sub-areas are defined in the subject principal area. This determination is made based on area information. If it is determined that sub-areas are defined (YES in step S202), the determining unit 306 proceeds to step S203. If it is determined that sub-areas are not defined (NO in step S202), the determining unit 306 proceeds to step S207.

In step S203, the determining unit 306 specifies one subject sub-area from among plural sub-areas contained in the subject principal area. The subject sub-area is sequentially specified according to a predetermined order.

In step S204, the determining unit 306 determines whether the positional relationship between the subject sub-area and the strikethrough satisfies a predetermined condition. In this example, the predetermined condition is a condition that the subject sub-area overlaps the strikethrough, that is, the strikethrough is at least partially contained in the subject sub-area. If it is determined that the positional relationship satisfies the predetermined condition (YES in step S204), the determining unit 306 proceeds to step S205. If it is determined that the positional relationship does not satisfy the predetermined condition (NO in step S204), the determining unit 306 proceeds to step S206.

In step S205, the determining unit 306 specifies, as data to be erased, items of writing data concerning all strokes included in the subject sub-area among the strokes indicated by the items of writing data stored in the storage unit 303. A stroke included in the subject sub-area is a stroke which is at least partially included in the subject sub-area.

In step S206, the determining unit 306 determines whether all sub-areas included in the subject principal area have been processed. If all the sub-areas have been processed (YES in step S206), the determining unit 306 proceeds to step S209. If a sub-area that has not been processed is found (NO in step S206), the determining unit 306 returns to step S203. In step S203, the subject sub-area is updated, and steps S204 through S206 are executed on the new subject sub-area.

In step S207, the determining unit 306 determines whether the positional relationship between the subject principal area and the strikethrough satisfies a predetermined condition. In this example, the predetermined condition is a condition that the subject principal area overlaps the strikethrough, that is, the strikethrough is at least partially contained in the subject principal area. If it is determined that the positional relationship satisfies the predetermined condition (YES in step S207), the determining unit 306 proceeds to step S208. If it is determined that the positional relationship does not satisfy the predetermined condition (NO in step S207), the determining unit 306 proceeds to step S209.

In step S208, the determining unit 306 specifies, as data to be erased, items of writing data concerning all strokes included in the subject principal area among the strokes indicated by the items of writing data stored in the storage unit 303. A stroke included in the subject principal area is a stroke which is at least partially included in the subject principal area.

In step S209, the determining unit 306 determines whether all subject principal area candidates have been processed. If a principal area that has not been processed is found (NO in step S209), the determining unit 306 returns to step S201. In step S201, the subject principal area is updated, and steps S202 through S209 are executed on the new subject principal area. If all the principal area candidates have been processed (YES in step S209), the determining unit 306 completes the processing.

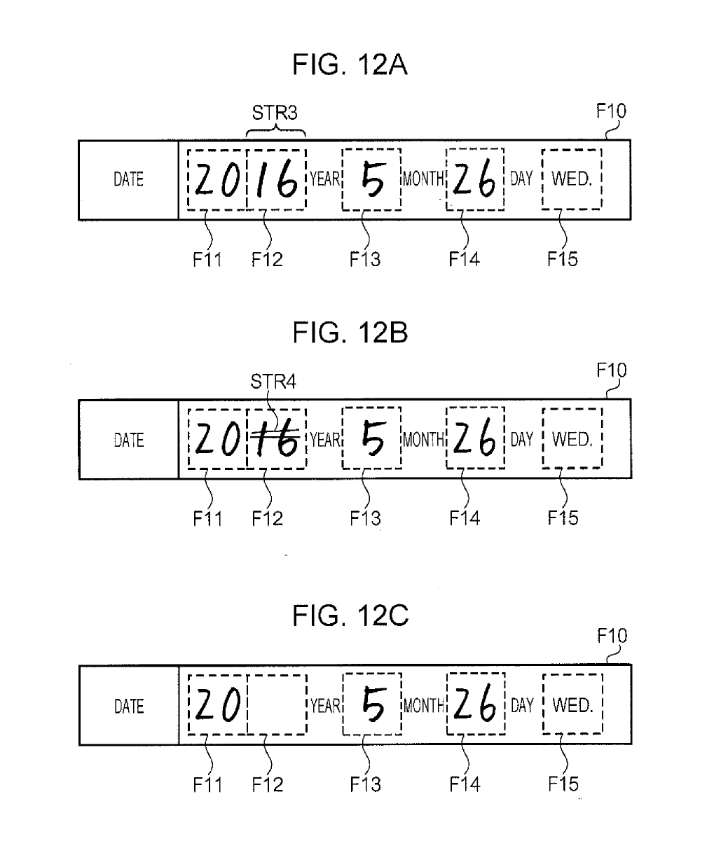

FIGS. 12A through 12C illustrate an example of erasing of strokes in the second operation example. In this example, a determination as to whether writing data will be erased is made for each sub-area, and thus, strokes can be erased in a more precise manner.

### 2-3. Third Operation Example

A third operation example will now be described below. In the third operation example, as well as in the second operation example, sub-areas are used. However, sub-areas in the third operation example are not defined by area information, but are determined according to writing data. More specifically, character recognition processing is performed on strokes indicated by writing data, and a circumscribed rectangle obtained for each recognized character is used as a sub-area.

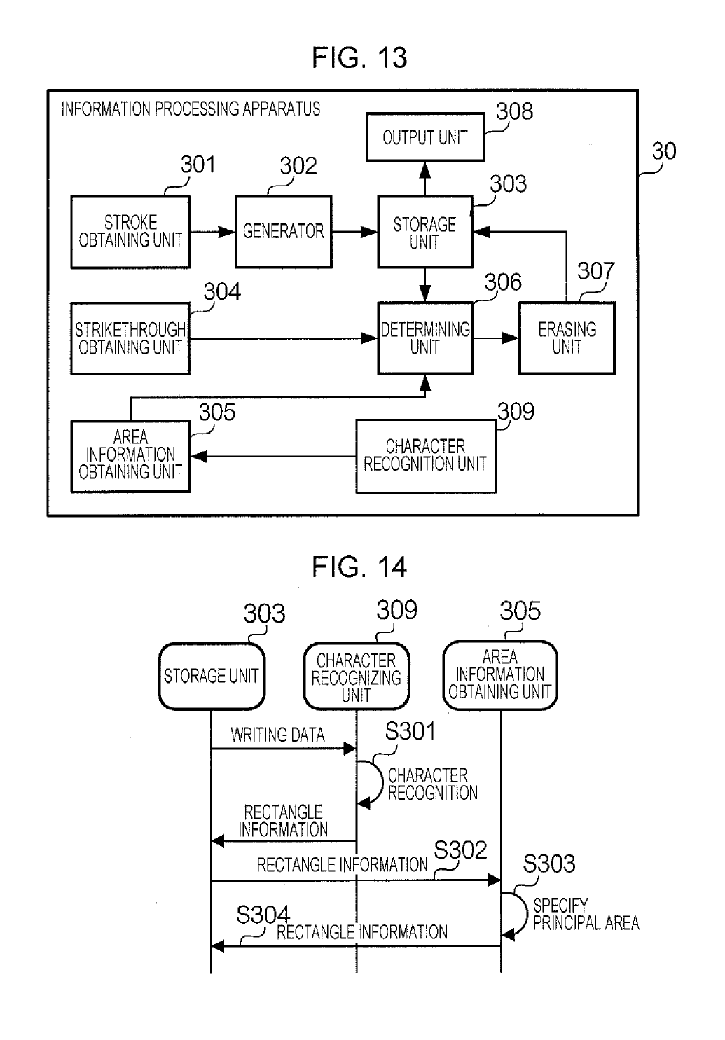

FIG. 13 illustrates an example of the functional configuration of the information processing apparatus 30 according to the third operation example. In this example, the information processing apparatus 30 includes a character recognition unit 309 in addition to the functions shown in FIG. 7. The character recognition unit 309 is implemented in the information processing apparatus 30 as a result of the CPU 31 executing a character recognition program on images. The character recognition program may be part of the digital pen program.

FIG. 14 is a sequence chart illustrating an example of the operation performed by the information processing apparatus 30 according to the third operation example. The processing in FIG. 14 is executed in parallel with the processing in FIGS. 8A and 8B, and is started in response to the generation of a new item of writing data, for example.

In step S301, the character recognition unit 309 performs character recognition processing on an image indicated by a new item of writing data. The character recognition processing includes processing for dividing a set of strokes into units that are estimated to be characters, that is, processing for dividing a set of strokes into individual characters. As a result, circumscribed rectangles are obtained for the individual characters. The storage unit 303 stores information for specifying the position and the size of the circumscribed rectangle of each character (hereinafter called “rectangle information”).

In step S302, the area information obtaining unit 305 reads the rectangle information stored in the storage unit 303. In step S303, the area information obtaining unit 305 specifies a principal area that overlaps the rectangle indicated by the rectangle information. In step S304, the area information obtaining unit 305 stores this rectangle information as information for specifying sub-areas included in this principal area in the storage unit 303.

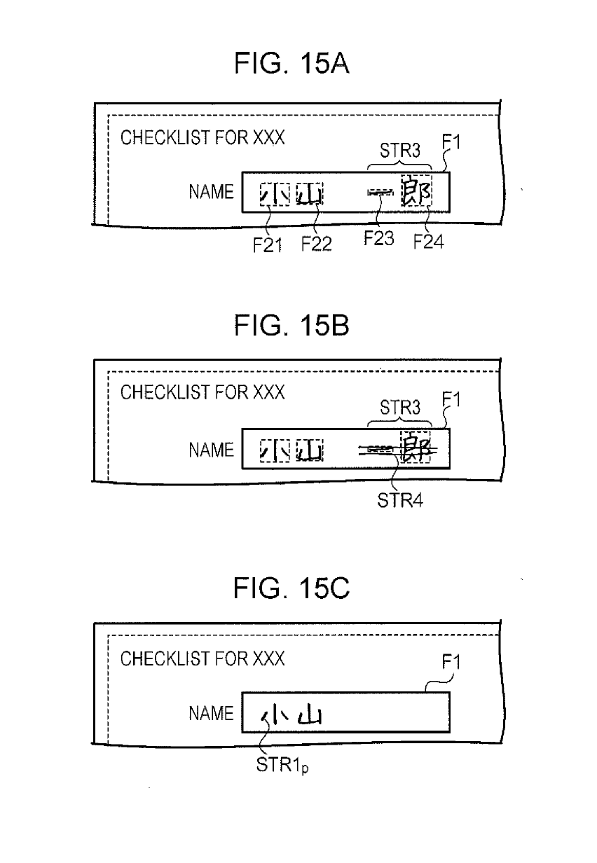

FIGS. 15A through 15C illustrate an example of erasing of strokes in the third operation example. FIG. 15A illustrates a stroke STR3 indicated by writing data and circumscribed rectangles obtained by character recognition processing. These circumscribed rectangles are indicated by sub-fields F21 through F24. FIG. 15B illustrates the stroke STR3 and also a stroke STR4 indicated by strikethrough data. In this example, the strikethrough (stroke STR4) overlaps the sub-fields F23 and F24. Hence, the writing data indicated by the stroke STR3 in the sub-fields F23 and F24 is erased, as shown in FIG. 15C.

Character recognition processing may not be necessarily started in response to the generation of a new item of writing data. Instead, character recognition processing may automatically be started at regular time intervals.

### 3. Modified Examples

The present invention is not restricted to the above-described exemplary embodiment, and various modifications may be made. Some modified examples will be described below, and two or more of the following modified examples may be combined.

The condition concerning the positional relationship used for specifying a subject area corresponding to strikethrough (hereinafter called a “first condition”) in step S109 and the condition concerning the positional relationship used for determining strokes to be erased from the subject area (hereinafter called a “second condition”) in step S110 are not restricted to the conditions discussed in the above-described exemplary embodiment. For example, the first condition may be a condition that the distance from the subject area to the strikethrough is equal to or smaller than a predetermined threshold. The second condition may be a condition that the distance from a stroke to the subject area is equal to or smaller than a predetermined threshold.

In the above-described exemplary embodiment, after writing data indicating the first path is generated, part of this writing data is erased according to the second path. Alternatively, the information processing apparatus 30 may perform: (1) obtaining stroke information indicating the first path and the second path; (2) specifying an area on the medium 10 that has a predetermined positional relationship with the second path; (3) generating writing data indicating the first path which does not overlap this specified area; and (4) outputting the generated writing data.

In the third operation example, instead of performing character recognition processing, processing for calculating a circumscribed polygon for a set of strokes may be performed. In this case, a set of strokes may not necessarily be a linguistically meaningful unit, and instead, a predetermined number of strokes may be grouped and a circumscribed polygon for this group of strokes may be calculated.

The relationships between the functions and hardware elements in the digital pen system 1 are not restricted to those discussed in the above-described exemplary embodiment. The hardware configurations of the digital pen 20 and the information processing apparatus 30 are only examples. At least some of the functional elements shown in FIG. 7 may be included in the digital pen 20. Alternatively, a system including two or more devices (for example, a server and a client in a network) may have the functions corresponding to the functional elements shown in FIG. 7.

The program executed by the CPU 31 may be provided as a result of being stored in a storage medium such as an optical disc, a magnetic disk, and a semiconductor memory, or being downloaded via a communication network such as the Internet. This program may not necessarily include all the steps shown in FIGS. 8A and 8B.

The foregoing description of the exemplary embodiment of the present invention has been provided for the purposes of illustration and description. It is not intended to be exhaustive or to limit the invention to the precise forms disclosed. Obviously, many modifications and variations will be apparent to practitioners skilled in the art. The embodiment was chosen and described in order to best explain the principles of the invention and its practical applications, thereby enabling others skilled in the art to understand the invention for various embodiments and with the various modifications as are suited to the particular use contemplated. It is intended that the scope of the invention be defined by the following claims and their equivalents.

What is claimed is:

1. A non-transitory computer readable medium storing a program causing a computer to execute a process, the process comprising:
generating a first path which represents positions on a medium specified by a digital pen;
obtaining a second path which represents positions on the medium specified by the digital pen and which satisfies a predetermined condition;
obtaining information for specifying an area on the medium, the area having a predetermined positional relationship with the second path; and
erasing the first path in accordance with a positional relationship between the area and the first path.

2. The non-transitory computer readable medium according to claim 1, wherein, in the obtaining of information for specifying an area on the medium, as the predetermined positional relationship, a condition that the area overlaps the second path is used.

3. The non-transitory computer readable medium according to claim 1, wherein:
in the obtaining of information for specifying an area on the medium, a plurality of sub-areas included in the area are obtained; and
in the erasing of the first path, concerning each of the plurality of sub-areas, data indicating at least part of an image object represented by the first path having a predetermined positional relationship with the sub-area is erased in accordance with a positional relationship between the sub-area and the second path.

4. The non-transitory computer readable medium according to claim 3, wherein, if a first sub-area among the plurality of sub-areas overlaps the second path, in the erasing of the first path, data indicating part of an image object represented by the first path corresponding to the first sub-area is erased.

5. The non-transitory computer readable medium according to claim 3, wherein, if a first sub-area among the plurality of sub-areas overlaps the second path, in the erasing of the first path, data indicating an image object represented by the first path included in the first sub-area is erased.

6. The non-transitory computer readable medium according to claim 3, the process further comprising:
determining the plurality of sub-areas in accordance with the first path.

7. The non-transitory computer readable medium according to claim 6, the process further comprising:
executing character recognition on the first path,
wherein, in the determining of the plurality of sub-areas, the plurality of sub-areas are determined by using a result of the character recognition.

8. An information processing apparatus comprising:
a generator that generates data indicating an image object in accordance with a first path which represents positions on a medium specified by a digital pen;
a first obtaining unit that obtains a second path which represents positions on the medium specified by the digital pen and which satisfies a predetermined condition;
a second obtaining unit that obtains information for specifying an area on the medium, the area having a predetermined positional relationship with the second path; and
an erasing unit that erases the first path in accordance with a positional relationship between the area and the first path.

9. A non-transitory computer readable medium storing a program causing a computer to execute a process, the process comprising:
obtaining first and second paths, the first path representing positions on a medium specified by a digital pen, the second path representing positions on the medium specified by the digital pen and satisfying a predetermined condition;
specifying an area on the medium, the area having a predetermined positional relationship with the second path; and
outputting data indicating the first path which does not overlap the specified area.
